(19) United States
(12) Patent Application Publication
(10) Pub. No.: US 2004/0139297 A1
(43) Pub. Date: Jul. 15, 2004

(54) System and method for scalable interconnection of adaptive processor nodes for clustered computer systems

(76) Inventor: Jon M. Huppenthal, Colorado Springs, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/340,400

(22) Filed: Jan. 10, 2003

(51) Int. Cl. G06F 15/00

(52) U.S. Cl. 712/15

(57) ABSTRACT

An adaptive, or reconfigurable, processor-based clustered computing system and methods utilizing a scalable interconnection of adaptive processor nodes comprises at least first and second processing nodes, and a cluster interconnect coupling the first and second processing nodes wherein at least the first processing node comprises an adaptable, or reconfigurable, processing element. In particular implementations, the second processing node of clustered computer may comprise a microprocessor, a reconfigurable processing element or a shared memory block and the cluster interconnect may be furnished as an Ethernet, Myrinet, cross bar switch or the like.

### CROSS REFERENCE TO RELATED PATENT APPLICATIONS

The present invention is related to the subject matter disclosed in U.S. patent application Ser. Nos. 10/142,045 filed May 9, 2002 for: “Adaptive Processor Architecture Incorporating a Field Programmable Gate Array Control Element Having at Least One Embedded Microprocessor Core” and 10/282,986 filed Oct. 29, 2002 for: “Computer System Architecture and Memory Controller for Close-Coupling Within a Hybrid Processing System Utilizing an Adaptive Processor Interface Port”, assigned to SRC Computers, Inc., Colorado Springs, Colo., assignee of the present invention, the disclosures of which are herein specifically incorporated by this reference in their entirety.

### BACKGROUND OF THE INVENTION

The present invention relates, in general, to the field of reconfigurable computing systems and methods. More particularly, the present invention relates to adaptive processor-based clustered computing systems and methods utilizing a scalable interconnection of adaptive processor nodes.

Advances in field programmable gate array (“FPGA”) technology have allowed adaptive, or reconfigurable, processors to become more and more powerful. Their ability to reconfigure themselves into only that circuitry needed by a particular application has been shown to yield orders of magnitude improvement in performance as compared to standard microprocessors. However, for various reasons, conventional adaptive processors have historically been relegated to use as microprocessor accelerators.

The first of these reasons is that the existing offerings are all slave processors connected via input/output (“I/O”) ports on the microprocessor host. As a result, such hybrid systems must have a one-to-one, or one-to-few pairing, of microprocessors to reconfigurable processors. Moreover, the number of reconfigurable processors utilized may be limited by the number of I/O slots on the host motherboard.

The second reason is that the existing offerings are difficult to program in that the user must develop the design for the FPGAs on the adaptive processor board independently of developing the program that will run in the microprocessor. This effectively serves to limit the use of adaptive processors to very special functions in which the user is willing to expend development time using non-standard languages to complete the required FPGA design.

Lastly, whether the reconfigurable processor resides on a single peripheral component interconnect (“PCI”) board with one FPGA or an I/O connected chassis containing an array of FPGAs, the long configuration time of the FPGAs and their connectivity to the host, forces them to be used by one user at a time working in conjunction with one application.

While each of these factors still serve to limit the current use of reconfigurable processors, there have been developments which will enable this to change in the near future. First, SRC Computers, Inc. has developed a proprietary compiler technology which allows a user to write a single program using standard high level languages such as C or Fortran, that will automatically be compiled into a single executable containing both code for the microprocessor and bit streams for configuring the FPGAs. This allows the user to automatically use microprocessors and reconfigurable processors together as true peers, without requiring any special a priori knowledge.

Secondly, newly introduced adaptive processor architectures disclosed, for example, in the aforementioned U.S. patent application Ser. No. 10/142,045, incorporate many features commonly found on the microprocessor host directly into the adaptive processor itself. These include, for example, sharable dynamic random access memory (“DRAM”), high speed static random access memory (“SRAM”) cache-like memory, I/O ports for direct connection to peripherals such as disk drives and the ability to use a file system to allow I/O operations.

These new adaptive processors such as the MAP™ series of adaptive processors (a trademark of SRC Computers, Inc.) can also now interconnect to the microprocessor with which they are working in a number of novel and advantageous ways. Certain of these new interconnects have also been disclosed, for example, in the aforementioned U.S. patent application Ser. No. 10/282,986 filed Oct. 29, 2002.

### SUMMARY OF THE INVENTION

What is disclosed herein is a technique for the scalable interconnection of adaptive processor nodes in a clustered computing system that allows much greater flexibility in the adaptive processor to microprocessor mix as well as the ability of multiple users to have access to varying complements of adaptive processors, microprocessors and memory.

Given an adaptive processor that has the on-board intelligence to operate its own connections to peripheral devices as described above, it is now possible to utilize it as an autonomous node in a clustered computing system. This cluster may be made up of, for example, a mix of microprocessor boards, adaptive processors and even sharable memory blocks with “smart” front ends capable of supporting the desired clustering or interconnect protocol.

In particular implementations, this clustering may be accomplished using industry standard clustering interconnects such as Ethernet, Myrinet and the like. It is also possible to interconnect the nodes via commercial or proprietary cross bar switches, such as those available from SRC Computers, Inc., to accomplish this interconnect. Clustered computing systems using standard clustering interconnects can also use standard clustering software to construct a “Beowulf Cluster” to provide a high-performance parallel computer comprising a large number of individual computers interconnected by a high-speed network.

In the case of a clustered computing system constructed using the SRC Computers, Inc. switch, U.S. patent application Ser. No. 10/278,345 filed Oct. 23, 2002 for: “Mechanism for Explicit Communication of Messages Between Processes Running on Different Nodes in a Clustered Multiprocessor System”, the disclosure of which is herein specifically incorporated by this reference, describes the software clustering constructs that may be used for control. Systems created in this manner now allow adaptive processing to become the premier standard method of computing. This configuration removes all of the historical “slave” limitations and gives the adaptive processor true peer access to all resources in the system. Because any microprocessor can access any adaptive processor or memory block in the system, a given user no longer must execute his program on a particular microprocessor node in order to use an already configured adaptive processor. In this fashion, the FPGAs on the adaptive processor boards do not need to be reconfigured if a different user on a different microprocessor wants to use the same function or if the operating system performs a context switch and moves the user to a different microprocessor in the system. This greatly minimizes the time lost by the system in reconfiguring FPGAs which has historically been one of the limiting factors in using adaptive processors.

Particularly disclosed herein is a system and method for a clustered computer system comprising at least two nodes wherein at least one of the nodes is a reconfigurable, or adaptive, processor element. In certain representative implementations disclosed herein, the clustering interconnect may comprise Ethernet, Myrinet or cross bar switches. A clustered computing system in accordance with the present invention may also comprise at least two nodes wherein at least one of the nodes is a shared memory block.

Specifically disclosed herein is a clustered computer system comprising at least first and second processing nodes, and a cluster interconnect coupling the first and second processing nodes wherein at least the first processing node comprises a reconfigurable processing element. In particular implementations, the second processing node of clustered computer may comprise a microprocessor, a reconfigurable processing element or a shared memory block.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a functional block diagram of a typical I/O connected hybrid computing system comprising a number of microprocessors and adaptive processors, with the latter being coupled to an I/O bridge;

FIG. 2 is a functional block diagram of a particular, representative embodiment of a multi-adaptive processor element incorporating a field programmable gate array (“FPGAs”) control element having embedded processor cores in conjunction with a pair of user FPGAs and six banks of dual-ported static random access memory (“SRAM”);

FIG. 3 is a functional block diagram of an autonomous intelligent shared memory node for possible implementation in a clustered computing system comprising a scalable interconnection of adaptive nodes in accordance with the present invention wherein the memory control FPGA incorporates the intelligence to operate its own connections to peripheral devices; and

FIG. 4 is a functional block diagram of a clustered computing system comprising a generalized possible implementation of a scalable interconnection of adaptive nodes in accordance with the present invention wherein clustering may be accomplished using standard clustering interconnects such as Ethernet, Myrinet, cross bar switches and the like.

### DESCRIPTION OF A REPRESENTATIVE EMBODIMENT

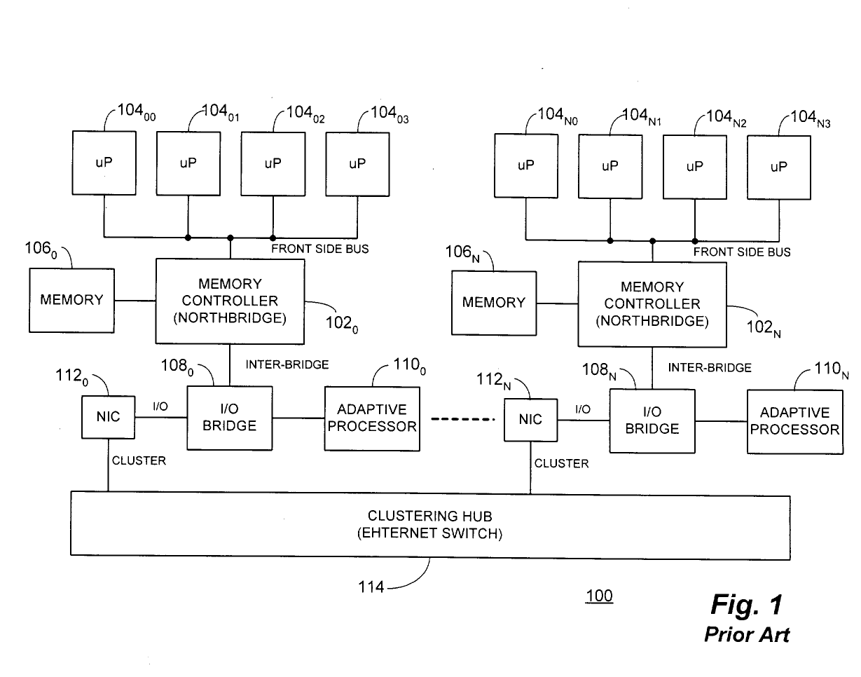

With reference now to FIG. 1, a functional block diagram of a typical I/O connected hybrid computing system 100 is shown. The hybrid computing system 100 comprises one or more North Bridge ICs 102₀ through 102_{N}, each of which is coupled to four microprocessors 104₀₀ through 104₀₃ through and including 104_{N0} through 104_{N3} by means of a Front Side Bus. The North Bridge ICs 102₀ through 102_{N} are coupled to respective blocks of memory 106₀ through 106_{N} as well as to a corresponding I/O bridge element 108₀ through 108_{N}. A network interface card (“NIC”) 112₀ through 112_{N} couples the I/O bus of the respective I/O bridge 108₀ through 208_{N} to a cluster bus coupled to a common clustering hub (or Ethernet Switch) 114.

As shown, an adaptive processor element 110₀ through 110_{N} is coupled to, and associated with, each of the I/O bridges 108₀ through 108_{N}. This is the most basic of the existing approaches for connecting an adaptive processor 110 in a hybrid computing system 100 and is implemented, essentially via the standard I/O ports to the microprocessor(s) 104. While relatively simple to implement, it results in a very “loose” coupling between the adaptive processor 110 and the microprocessor(s) 104 with resultant low bandwidths and high latencies relative to the bandwidths and latencies of the processor bus. Moreover, since both types of processors 104, 110 must share the same memory 106, this leads to significantly reduced performance in the adaptive processors 110. Functionally, this architecture effectively limits the amount of interaction between the microprocessor(s) 204 and the adaptive processor 110 that can realistically occur.

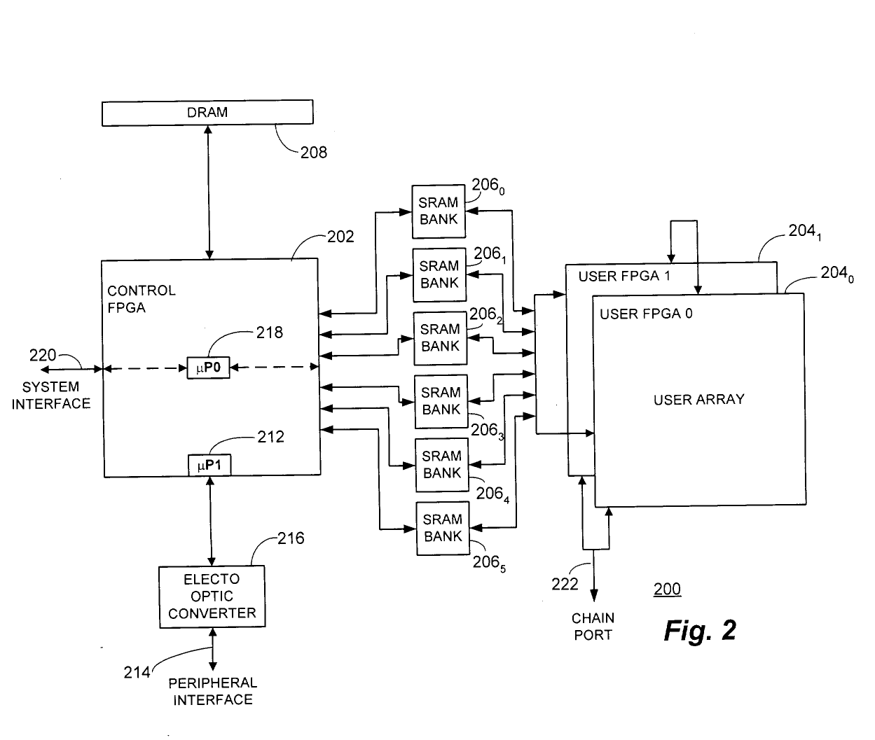

With reference now to FIG. 2, a functional block diagram of a particular, representative embodiment of a multi-adaptive processor element 200 is shown. The multi-adaptive processor element 200 comprises, in pertinent part, a discrete control FPGA 202 operating in conjunction with a pair of separate user FPGAs 204₀ and 204₁. The control FPGA 202 and user FPGAs 204₀ and 204₁ are coupled through a number of SRAM banks 206, here illustrated in this particular implementation, as dual-ported SRAM banks 206₀ through 206₅. An additional memory block comprising DRAM 208 is also associated with the control FPGA 202.

The control FPGA 202 includes a number of embedded microprocessor cores including μP1 212 which is coupled to a peripheral interface bus 214 by means of an electro optic converter 216 to provide the capability for additional physical length for the bus 214 to drive any connected peripheral devices (not shown). A second microprocessor core μP0 218 is utilized to manage the multi-adaptive processor element 200 system interface bus 220, which although illustrated for sake of simplicity as a single bi-directional bus, may actually comprise a pair of parallel unidirectional busses. As illustrated, a chain port 222 may also be provided to enable additional multi-adaptive processor elements 200 to communicate directly with the multi-adaptive processor element 200 shown.

The overall multi-adaptive processor element 200 architecture, as shown and previously described, has as its primary components three FPGAs 202 and 204₀, 204₁, the DRAM 208 and dual-ported SRAM banks 206. The heart of the design is the user FPGAs 204₀, 204₁ which are loaded with the logic required to perform the desired processing. Discrete FPGAs 204₀, 204₁ are used to allow the maximum amount of reconfigurable circuitry. The performance of this multi-adaptive processor element 200 may be further enhanced by using two such FPGAs 204 to form a user array.

The dual-ported SRAM banks 206 are used to provide very fast bulk memory to support the user array 204. To maximize its volume, discrete SRAM chips may be arranged in multiple, independently connected banks 106₀ through 206₅ as shown. This provides much more capacity than could be achieved if the SRAM were only integrated directly into the FPGAs 202 and/or 204. Again, the high input/output (“I/O”) counts achieved by the particular packaging employed and disclosed herein currently allows commodity FPGAs to be interconnected to six, 64 bit wide SRAM banks 206₀ through 206₅ achieving a total memory bandwidth of 4.8 Gbytes/sec.

Typically the cost of high speed SRAM devices is relatively high and their density is relatively low. In order to compensate for this fact, dual-ported SRAM may be used with each SRAM chip having two separate ports for address and data. One port from each chip is connected to the two user array FPGAs 204₀ and 204₁ while the other is connected to a third FPGA that functions as a control FPGA 202. This control FPGA 202 also connects to a much larger high speed DRAM 208 memory dual in-line memory module (“DIMM”). This DRAM 108 DIMM can easily have 200 times the density of the SRAM banks 206 with similar bandwidth when used in certain burst modes. This allows the multi-adaptive processor element 200 to use the SRAM 206 as a circular buffer that is fed by the control FPGA 202 with data from the DRAM 208 as will be more fully described hereinafter.

The control FPGA 202 also performs several other functions. In a preferred embodiment, control FPGA 202 may be selected from the Virtex Pro family available from Xilinx, Inc. San Jose, Calif., which have embedded Power PC microprocessor cores. One of these cores (μP0 218) is used to decode control commands that are received via the system interface bus 220. This interface is a multi-gigabyte per second interface that allows multiple multi-adaptive processor elements 200 to be interconnected together. It also allows for standard microprocessor boards to be interconnected to multi-adaptive processor elements 200 via the use of SRC SNAP™ cards. (“SNAP” is a trademark of SRC Computers, Inc., assignee of the present invention; a representative implementation of such SNAP cards is disclosed in U.S. patent application Ser. No. 09/932,330 filed Aug. 17, 2001 for: “Switch/Network Adapter Port for Clustered Computers Employing a Chain of Multi-Adaptive Processors in a Dual In-Line Memory Module Format” assigned to SRC Computers, Inc., the disclosure of which is herein specifically incorporated in its entirety by this reference.) Packets received over this interface perform a variety of functions including local and peripheral direct memory access (“DMA”) commands and user array 204 configuration instructions. These commands may be processed by one of the embedded microprocessor cores within the control FPGA 202 and/or by logic otherwise implemented in the FPGA 202.

To increase the effective bandwidth of the system interface bus 220, several high speed serial peripheral I/O ports may also be implemented. Each of these can be controlled by either another microprocessor core (e.g. μP1 212) or by discrete logic implemented in the control FPGA 202. These will allow the multi-adaptive processor element 200 to connect directly to hard disks, a storage area network of disks or other computer mass storage peripherals. In this fashion, only a small amount of the system interface bus 220 bandwidth is used to move data resulting in a very efficient system interconnect that will support scaling to high numbers of multi-adaptive processor elements 200. The DRAM 208 on board any multi-adaptive processor element 200 can also be accessed by another multi-adaptive processor element 200 via the system interface bus 220 to allow for sharing of data such as in a database search that is partitioned across several multi-adaptive processor elements 200.

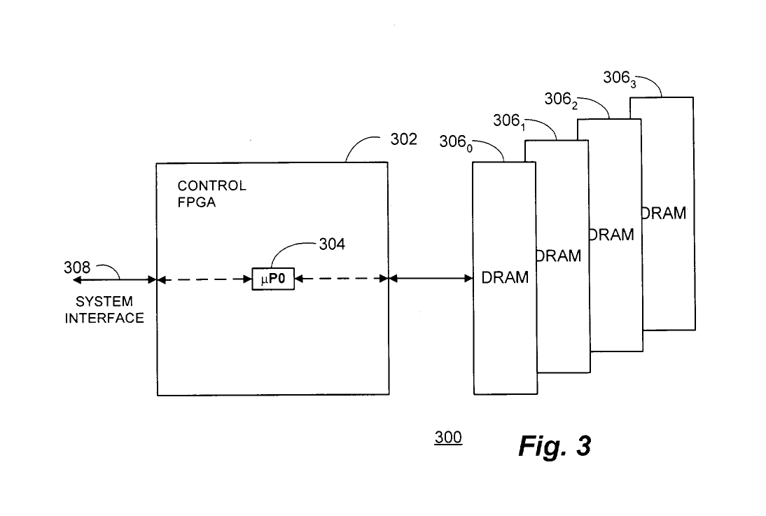

With reference additionally now to FIG. 3, a functional block diagram of an autonomous shared memory node 300 for possible implementation in a clustered computing system comprising a scalable interconnection of adaptive nodes in accordance with the present invention is shown. The memory node 300 comprises, in pertinent part, a control FPGA 302 incorporating a microprocessor core 304. The FPGA 302 may be coupled to a number of DRAM banks, for example, banks 306₀ through 306₃ as well as to a system interface 308 of the overall clustered computing system. In this illustration, the control FPGA 302 incorporates the intelligence to operate its own connections to the clustering medium. In a representative embodiment, a clustered computing system comprising a number of memory nodes 300 could be made up of a mix of microprocessor boards and adaptive processors with “smart” front ends capable of supporting the desired clustering or interconnect protocol.

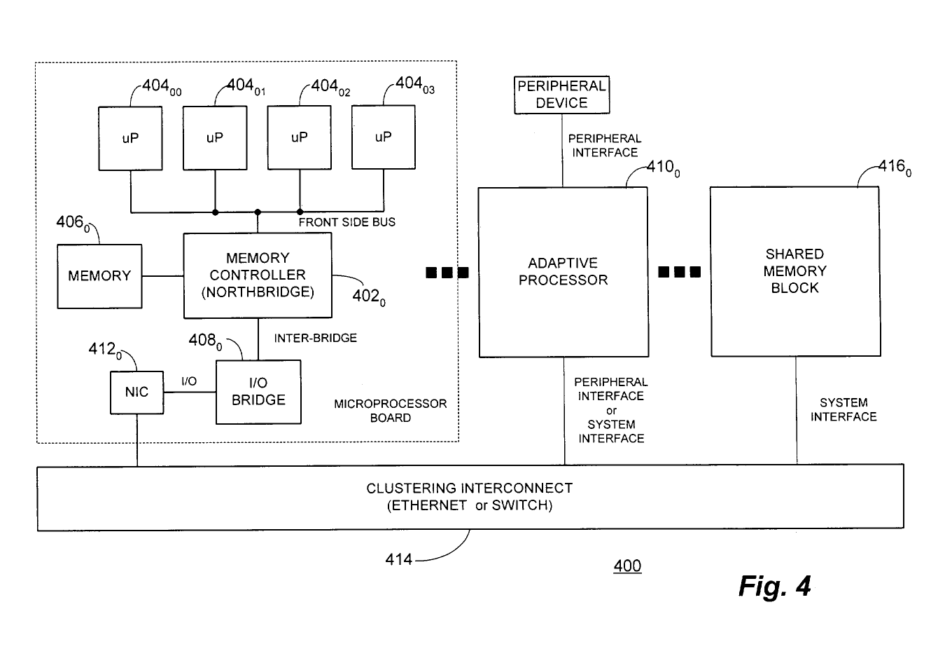

With reference additionally now to FIG. 4, a functional block diagram of a clustered computing system 400 is shown comprising a generalized implementation of a scalable interconnection of adaptive nodes in accordance with the present invention and wherein the clustering may be accomplished using standard clustering interconnects such as Ethernet, Myrinet or other suitable switching and communication mechanisms.

The clustered computing system 400 comprises, in pertinent part, one or more microprocessor boards, each having a memory controllers 402₀ each of which is coupled to a number of microprocessors 404₀₀ through 404₀₃ by means of a Front Side Bus. The memory controller 402₀ is coupled to a respective block of memory 406₀ as well as to a corresponding I/O bridge element 408₀. A NIC 412₀ couples the I/O bus of the respective I/O bridge 408₀ to a clustering interconnect 414.

As shown, one or more adaptive, or reconfigurable, processor elements 410₀ are coupled to the clustering interconnect 414 by means of a peripheral interface or the system interface bus. In like manner one or more shared memory blocks 416₀ are also coupled to the clustering interconnect 414 by means of a system interface bus. In a representative embodiment, the clustering interconnect may comprise an Ethernet, Myrinet or other suitable communications mechanism. The former is a standard for network communication utilizing either coaxial or twisted pair cable and is used, for example, in local area networks (“LANs”). It is defined in IEEE standard 802.3. The latter is a high-performance, packet-based communication and switching technology that is widely used to interconnect clusters of workstations, personal computers (“PCs”), servers, or single-board computers. It is defined in American National Standard ANSI/VITA 26-1998.

While there have been described above the principles of the present invention in conjunction with specific configurations of adaptive nodes and clustered computer systems, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

What is claimed is:

1. A clustered computer system comprising:
at least first and second processing nodes;
a cluster interconnect coupling said first and second processing nodes
wherein at least said first processing node comprises a reconfigurable processing element.

2. The clustered computer system of claim 1 wherein at least said second processing node comprises a reconfigurable processing element.

3. The clustered computer system of claim 1 wherein at least said second processing node comprises a microprocessor-based processing element.

4. The clustered computer system of claim 1 further comprising:
at least one shared memory block coupled to said cluster interconnect for access by said at least first and/or second processing nodes.

5. The clustered computer system of claim 1 wherein said cluster interconnect comprises an Ethernet.

6. The clustered computer system of claim 1 wherein said cluster interconnect comprises a Myrinet.

7. The clustered computer system of claim 1 wherein said cluster interconnect comprises a cross bar switch.

8. The clustered computer system of claim 1 wherein said first processing node is coupled to said cluster interconnect through a peripheral interface.

9. The clustered computer system of claim 1 wherein said first processing node comprises:
a control block including at least one processing element for coupling said first processing node to said cluster interconnect.

10. The clustered computer system of claim 9 wherein said control block comprises a control FPGA.

11. The clustered computer system of claim 9 wherein said first processing node further comprises:
at least one user array coupled to said control block through a dual-ported memory block.

12. The clustered computer system of claim 11 wherein said at least one user array comprises a user FPGA.

13. The clustered computer system of claim 12 wherein said user FPGA comprises a chain port for coupling said first processing node to another processing node.

14. A multi-node computer system comprising:
a cluster interconnect;
a reconfigurable processing element coupled to said cluster interconnect; and
a memory block coupled to said cluster interconnect.

15. The multi-node computer system of claim 14 further comprising:
another processing element coupled to said cluster interconnect.

16. The multi-node computer system of claim 15 wherein said another processing element comprises a second reconfigurable processing element.

17. The multi-node computer system of claim 15 wherein said another processing element comprises a microprocessor-based processing element.

18. The multi-node computer system of claim 15 wherein said reconfigurable processing element and said another processing element may both access said memory block.

19. The multi-node computer system of claim 14 wherein said cluster interconnect comprises an Ethernet.

20. The multi-node computer system of claim 14 wherein said cluster interconnect comprises a Myrinet.

21. The multi-node computer system of claim 14 wherein said cluster interconnect comprises a cross bar switch.

22. The multi-node computer system of claim 14 wherein said reconfigurable processing element is coupled to said cluster interconnect through a peripheral interface.

23. The multi-node computer system of claim 14 wherein said reconfigurable processing element comprises:
a control block including at least one processor for coupling said first processing node to said cluster interconnect.

24. The multi-node computer system of claim 23 wherein said control block comprises a control FPGA.

25. The multi-node computer system of claim 23 wherein said reconfigurable processing element further comprises:
at least one user array coupled to said control block through a dual-ported memory block.

26. The multi-node computer system of claim 25 wherein said at least one user array comprises a user FPGA.

27. The multi-node computer system of claim 26 wherein said user FPGA comprises a chain port for coupling said reconfigurable processing element to another processing element.
